(19) United States
(12) Patent Application Publication
(10) Pub. No.: US 2005/0195739 A1
(43) Pub. Date: Sep. 8, 2005

(54) Protecting a network using protected working capacity envelopes

(76) Inventors: Wayne D. Grover, Edmonton (CA); Ganxiang Shen, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/064,766

(22) Filed: Feb. 23, 2005

Related U.S. Application Data
(60) Provisional application No. 60/546,161, filed on Feb. 23, 2004.

(51) Int. Cl. H04J 3/14; H04J 1/16; H04L 1/00; H04L 12/26

(52) U.S. Cl. 370/225; 370/229

(57) ABSTRACT

A method of protecting a telecommunications network comprising plural nodes connected by plural spans and having working capacity. The method comprising the steps of determining the spare capacity necessary to protect at least some of the working capacity of the telecommunications network; implementing a protected working capacity envelope based on the spare capacity determined; and analyzing the protected working capacity envelope to increase the protected working capacity.

### CROSS-REFERENCE TO RELATED APPLICATIONS

This application claims the benefit of priority under 35 USC 119(e) of U.S. provisional patent application No. 60/546,161 filed Feb. 23, 2004.

### BACKGROUND OF THE INVENTION

Optical networking has undergone impressive advancement in capacity and reach, and signaling standards have been developed to support dynamically switched lightpath services. It seems noteworthy, however, that essentially only one basic approach to dynamic provisioning of protected lightpaths has been considered: the paradigm of a working primary path and a predetermined disjoint backup route, both established end to end at provisioning time. For efficiency, the protection channels to form backup routes are shared over backup routes associated with other primary paths that have no common failure elements; that is, their primaries are not found together in any shared risk link groups (SRLGs). The basic scheme is illustrated in FIG. 1. Three working paths 102, 104 and 106 are established in network 100 as well as three corresponding backup routes 108, 110, 112, where protection sharing is possible on spans 114, 116, 118 as shown. Upon failure, end nodes of affected paths switch over, and intermediate nodes on the backup routes crossconnect shared protection channels to form the required backup path(s). For example, if span 120 were to fail, nodes 122 and 124 switch over to the backup route 108 which uses spans 126, 108 and 128 and intermediate nodes 130 and 132. End nodes choose their own primary route and make their shared backup path arrangements at provisioning time based on a global view of topology, capacity, SRLG data, and current sharing arrangements on each span.

Shared backup path protection (SBPP) has several desirable features. It allows protection to be arranged (or not) at the discretion of the user and lets the user know the route of their backup path in advance if failure occurs. It also achieves a protection-to-working capacity ratio (redundancy) that is very efficient compared to dedicated 1+1 APS and close to that of networks protected by optimal dynamic-adaptive path restoration. SBPP also requires that only the end nodes detect primary path failure to initiate backup path activation and switchover functions. In all-optical networks this can be important because immediate fault location is not required: it does not matter where on the primary the failure occurred—the switchover to the one predefined backup route occurs.

The popularity of this paradigm in the optical networking community is enormous; it is hard to find papers that do not just assume SBPP as the paradigm for dynamic automated provisioning of protected services. One finds discussion of the relative merits of distributed peer-to-peer control vs. a more traditional control plane and network management system (NMS), but under either form of control we still see SBPP as the predominant idea of how dynamic protected lightpath services would be established. This is not to say that other protection and restoration schemes such as span protection, p-cycles, and end-to-end path restoration are not known and widely studied, but it is the concept of dynamic provisioning in conjunction with protection assurance we are addressing here. While SBPP links the provisioning process and protection scheme together intimately, this need not always be the case. Under the protected working capacity envelope concept presented in this patent document, dynamic provisioning can be separate from the protection mechanism(s) employed.

Despite its dominance, however, there would seem to be grounds for concern with the SBPP approach, mainly pertaining to the amount of signaling and dynamic maintenance of state databases required in each node, especially if we consider highly dynamic demand in a large network. A basic assumption of SBPP is that an up-to-date database is available in every service provisioning node (or NMS) that includes complete Open Shortest Path First with Traffic Engineering (OSPF-TE) information (topology and capacities of every link), and all spare channel sharing relationships and shared risk entities that exist in the entire network (or domain). The concern is not simply that fairly large databases must be maintained in every node or in a centralized NMS, but rather with the assumption that correct network-wide dissemination of capacity and shareability state changes will be almost immediately known in all nodes for every connection setup and takedown in the network. In other words, the state data every node (or the NMS) must have is both global in extent and (even if state summarization methods are used to reduce the signaling volume) is updated on the same timescale as the connection changes themselves. This is the inherent architectural property of concern. Even if measures are taken to reduce signaling volumes with thresholds and summarization, the scheme is fundamentally dependent on per-connection state changes. Thus, there seems reason to be concerned about scalability with domain size and the frequency of connection requests/releases.

Consider that if the time to update the entire domain (or NMS) following a new SBPP path establishment (or takedown) is just 100 ms, the network as a whole could not reliably process more than 10 arrival/departure events per second. This seems inconsistent with the vision of future optical transport domains supporting thousands of lightpaths on hundreds of node pairs set up in response to minute-by-minute changes in end node capacity requirements. If millions of transactions must be handled day after day with essentially zero errors, any scheme that has to disseminate global state changes for every connection change (or even summarized batches of such changes) is inherently limited relative to a scheme where the state information depended on by end nodes for provisioning does not change at all, or changes only on a timescale hundreds or thousands of times longer than that of individual connections. This motivates the proposal for an alternate paradigm for dynamic provisioning of protected services

### SUMMARY OF THE INVENTION

We propose an alternative paradigm for consideration, partly summed up as “provisioning over protected capacity, rather than provisioning protection.” Under a given distribution of spare capacity, locally acting protection or restoration schemes create an “envelope” of protected working channels. Dynamic provisioning within this envelope is simplified to a shortest path routing problem and (depending on the mode of operation) requires little or no dissemination of state changes on a per-connection basis. We explain how existing “static” capacity design methods can be adapted to the dimensioning of such a working capacity envelope and the envelope dimensions further adapted online to track evolution of the overall pattern of random demand. An important property is that nothing needs to be done to arrange protection for services on the per-connection timescale other than routing the service itself. Arbitrarily fast-paced demand arrivals and departures can be accommodated within a static distribution of spare capacity. Adjustments to the envelope itself are required only on the timescale on which the statistical parameters of the random demand changes. This may provide an inherently more scalable, less database-dependent, and higher-availability alternative than SBPP, or at least an additional service modality that can be offered to customers.

There is therefore provided according to an aspect of the invention a method of protecting a telecommunications network having working capacity. An initial method step includes establishing a set of spare capacity necessary to protect at least some of the working capacity of the telecommunications network. The set of spare capacity defines a protected working capacity envelope. The protected working capacity is increased by analyzing and using spare capacity within the protected working capacity envelope. Establishing the protected working capacity envelope may comprise using an adaptive span restoration strategy, cycle covers, p-cycles, or bidirectional line switched rings. Analyzing spare capacity within the protected working capacity envelope to increase the protected working capacity may comprise using forcer analysis or using a restorability observer, where the restorability observer is able to adapt the protected working capacity envelope based on current demand patterns.

According to another aspect of the invention, there is provided a method of operating a telecommunications network; comprising the steps of establishing a protected working capacity envelope; receiving a request to transmit information between two nodes; determining the lowest cost route through the protected working capacity envelope between the two nodes; and connecting the nodes and spans along the lowest cost route to establish a connection between the two nodes. Receiving a request to transmit information between two nodes may further comprise the step of classifying the route as assured protection, best effort, no protection, or preemptible. The classification of the route may be changed as the limits of the network capacity are approached. Determining the lowest cost route may be based on factors selected from the group consisting of the number of hops in the route, the amount of available working capacity in each span of the route, the physical distance of the route, cost coefficients for spans, and cost coefficients for nodes. Spans or nodes may update the cost coefficients based on the amount of working capacity being used.

### BRIEF DESCRIPTION OF THE DRAWINGS

There will now be given a brief description of preferred embodiments of the invention, with reference to the drawings, by way of illustration only and not limiting the scope of the invention, in which like numerals refer to like elements, and in which:

FIG. 1 is an example of primary and backup paths under SBPP in the prior art;

FIG. 2 is an example of a PWCE protected network according to the present invention on the network shown in FIG. 1;

FIG. 3(a) is a span-restorable mesh network;

FIGS. 3(b)-(d) are examples of different possible dynamic demand patterns under the protected working capacity quantities of FIG. 3(a);

FIG. 4 is a flow diagram showing how static planning models support dynamic provisioning.

FIG. 5 is an example of how the PWCE concept can cope with dynamic adaptive boundaries;

FIG. 6 is an example of PWCE for a p-cycle network based on the conventional survivable network design;

FIG. 7(a) through (e) shows construction of a network based on the forcer structure exploitation; and

FIG. 8 is a chart representing the taxonomy of PWCE design models.

### DETAILED DESCRIPTION OF THE PREFERRED EMBODIMENT

The Concept of a Protected Working Capacity Envelope

The concept of a protected working capacity envelope (PWCE) starts with conventional survivable network design for static traffic demands. Given a demand-forecast, a survivability scheme is applied to design a network where the restorability is guaranteed for any one failure at a time. In networks based on span protection this results in a division of capacity into working and spare. The working capacity serves the demands in the forecasted matrix and the spare capacity provides protection for the working capacity.

At the first glance, such design methods seem limited to static demand problems and not helpful for dynamic service provisioning at all. However, even if designed for a specific static demand matrix, the result is a set of working channels on each span of the network that can actually support many different demand patterns, not only the one exemplar to which it was designed. Every configuration of a network of total capacities into a set of working channels and a corresponding reserve network to protect those channels, therefore has an associated set of demand matrices for which full routing is feasible under the working capacities present. In the space of all possible demand matrices, the set of such feasible demand patterns thus defines an operational envelope within which any number of demands can come and go as long as the resultant instantaneous demand combination lies within the envelope. Thus, the way in which existing theory for “static demand” design problems relates to networks with dynamic provisioning can be fairly simple: we need only extend such methods to address the question of designing the best envelope for operational use. Defining the “best operational envelope” will involve two general notions: For a given cost, we want the operating envelope to be (in a sense to be defined) as large as possible. We will also want the envelope also to be (in another sense to be defined), structured or shaped well to support the characteristic pattern of demand that is expected, even though individual demands will be completely random, and the exact pattern of overall demand may itself also be uncertain.

Thus, PWCE-based provisioning involves provisioning over inherently protected capacity, as opposed to explicitly provisioning protection for every service. If you can route the service through the available channels of a PWCE then the service is inherently protected, simply by routing it. Provisioning protected services looks the same as point-to-point routing over a non-protected network. One does not have to make any explicit arrangements for protection of every individual path or globally update network state for every individual path setup (or takedown).

A PWCE is based on locally-acting span restoration or protection mechanisms and off-line (or very slowly acting) capacity configuration planning to manage the operating envelope in current use (in fact adapting the envelope to evolutionary change in the average demand pattern.) The latter capability, of adapting the envelope is a sense in which such networks truly can cope with uncertainty in the demand pattern, not just randomness of individual demands. Some examples of mechanisms that protect bearer capacity (i.e., channels, not paths) which are well-known in the art are adaptive span restoration or preplanned span protection, cycle covers, generalized loop back networks, or p-cycles. Bidirectional line switched rings (BLSRs) also inherently protect bearer capacity and, under a suitable transformation (representing the constraints on routing between available rings), are also amenable to the PWCE strategy. (In the sense that follows, rings provide a static PWCE that could be useful for network migration into an integrated ring-mesh PWCE operational environment.) If network level protection against node failures is required (in addition to span failure protection), the corresponding mechanisms may be node-inclusive span restoration, node-encircling p-cycles, or recourse to a centralized multicommodity maximum flow rerouting solution for the transiting flows. All these options can be preplanned for a very fast localized response against single span failures, complemented by a slower but highly effective adaptive response to multiple failures, including node failures. FIG. 2 uses the general structure of a span-restorable network to portray some of the concepts of a PWCE.

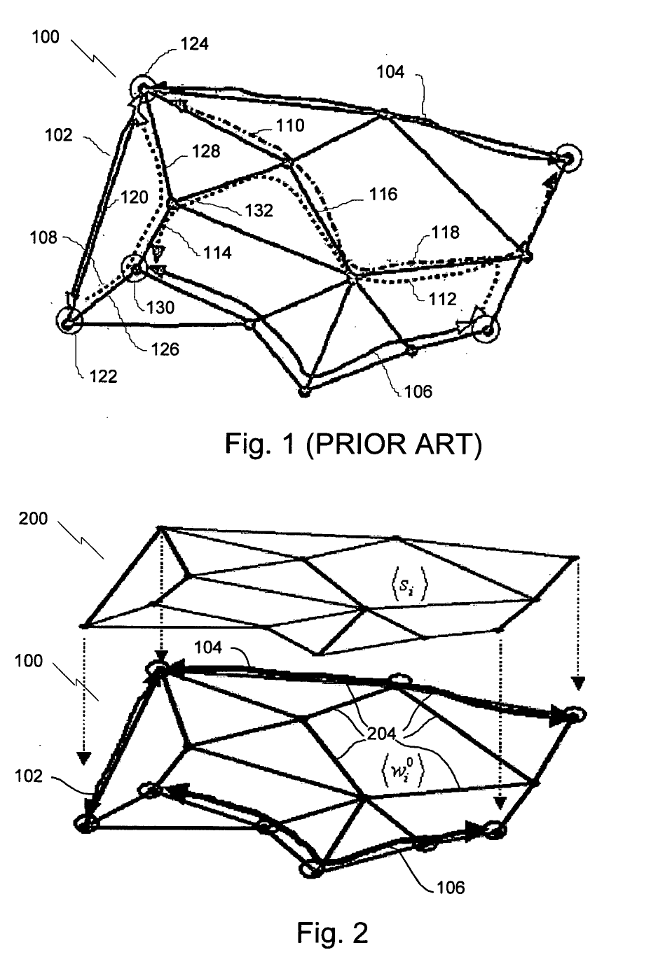

In the top of FIG. 2, a set-aside of spare channels on each span defines a reserve network 200 of spare capacities <sᵢ>. Under span restoration (or pre-planned span protection), any distribution of spare channels 200 provides for a certain corresponding maximum number of protected working channels <wᵢ⁰> on each span 204 below. An accurate approximation for a good restoration algorithm is that it will achieve capacity equal to the minimum cut between end nodes of the failed span through the reserve network <sᵢ>. In the lower part of FIG. 2, the same three services paths 102, 104 and 106 as in FIG. 1 are shown again. There are no per-path protection arrangements to make because the channels used for provisioning in the working layer are themselves protected by the reserve network 200. In other words as long the <wᵢ⁰> quantities on spans 204 support routing of the demand, it is inherently protected end-to-end with no further action. Local marking of the channels employed in provisioning a new path, according to its service class, immediately indicates to the local protection process whether the channel is to be included in assured protection, best effort, no protection, or is even preemptible. The same local marking indicates to subsequent dynamic path setups that arrive at the node that the individual channel is no longer available, but no other nodes need an accounting of individual channel states as they do in SBPP because sharing relationships are defined precisely between individual paths and individual backup channels. Under PWCE other nodes need only know that the span continues to have one or more further provisionable channels available, and this is the default case. The default case requires no state dissemination, so no signaling is involved.

Nodes operating under PWCE thus need only participate in simple OSPF-type topology discovery (not OSPF-TE) to support distributed end-node provisioning via CR-LDP. At this level of transport, basic topology is almost never changing, so this is an almost one-time learning of the basic graph topology. Full-blown OSPF-TE dissemination of more frequent and detailed changes in actual capacity and shareability/SRLG state on each span is not needed because every edge of the graph will remain available for routing as long as its current in-use channel count is below the maximum number of working channels <wᵢ⁰> that can be protected on this span. Nodes can be told via a centralized NMS the dimension of the PWCE (the <wᵢ⁰>) on each of its incident spans, based on the distribution of the spare capacity on other spans in the network. This is a database of only one number per span to be maintained. Alternately, the <wᵢ⁰> information may be infrequently discovered autonomously by each node by running a mock restoration trial using a distributed restoration algorithm executed in the background only within the spare capacity. For now, however, let us consider a network in which the spare capacity of each span is a preassigned fixed number of channels, which defines a static PWCE that need not be rediscovered or updated by a central NMS.

Through the theory of span-restorable networks, once the graph (G) and the vector of spare channel quantities on the network spans <sᵢ> are given, there is a unique maximum number of protected working channels available on each span <wᵢ⁰>. <wᵢ⁰> is in effect the answer to the question “If span i fails, then by rerouting through the spare capacity of the surviving graph between end nodes of i, what is the maximum number of replacement path segments I can create?” Thus, a given distribution of spare capacity on a graph creates a uniquely determinable envelope of protected working capacity on each span, <wᵢ⁰>. Provisioning of any new protected service path is then only a matter of routing over the shortest path through the envelope. Through the envelope means choosing any route over spans that are currently available in the OSPF simple graph view, that is, all spans where w⁰−wᵢ⁰> thres, where wᵢ is the current number of in-use channels (of protected status) on span i and thres is a policy threshold at which a link state advertisement (LSA) would be issued indicating, in effect, “span i is nearing the envelope” (and so please defer or raise the “cost” of further routing over span i). Thus, in a network where the <sᵢ> distribution creates a PWCE that is well matched and dimensioned for the current average point-to-point demand intensities, there is no state-update signaling whatsoever, regardless of how fast individual demands are randomly coming and going through this envelope. The only signaling involved is for source-routed establishment of new working paths (or release of unneeded paths). Only if the random pattern of dynamic demand evolves in a way such that a span approaches the envelope is any updated network state dissemination required. A single LSA then either withdraws the highly utilized span from further routing availability or (alternately) issues an updated logical cost for OSPF-type routing over that span. (Hysteresis would be applied before re-announcing availability of the span following later connection departures.)

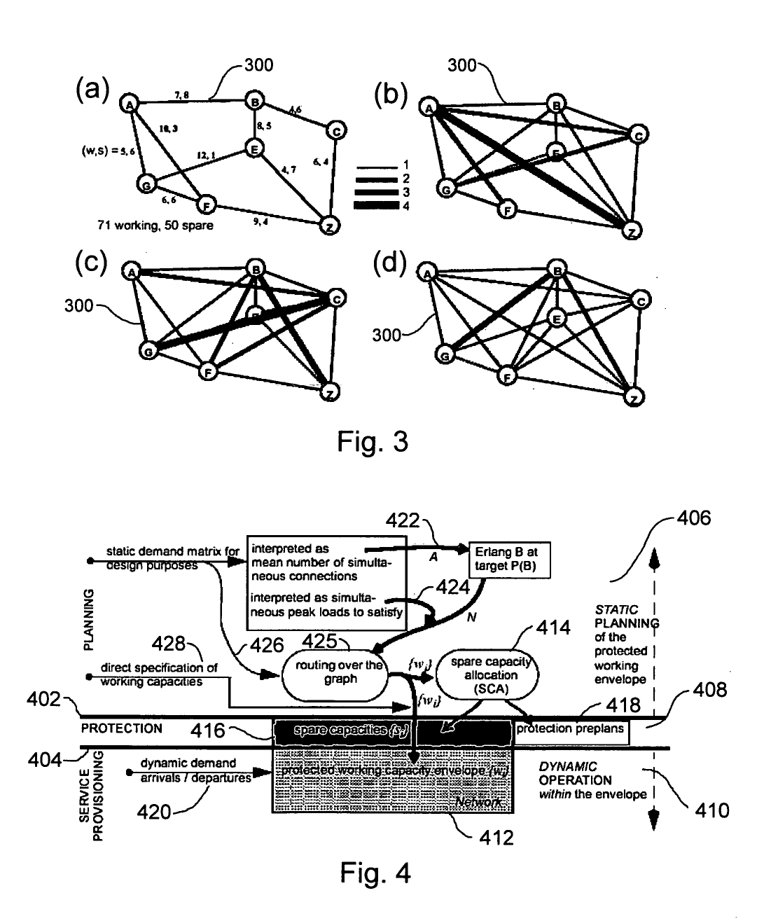

Thus, the set of all protected channel capacities <wᵢ⁰>=f (G, <sᵢ>) on network spans constitutes an operating envelope within which a vast number of simultaneous service path combinations are feasible, all inherently protected. Service provisioning is truly simplified to “point and click” (or the automated equivalent) following a single shortest path. FIG. 3 is a more detailed example of how a set of spare channels <sᵢ>, themselves completely unseen by the dynamic provisioning process, enable a corresponding envelope of protected working capacity <wᵢ⁰>. FIG. 3a shows a simple example of a set of spare capacities on a 10-span graph 300 with nodes A, B, C, E, F, G, and Z and the corresponding PWCE they provide under span restoration, where the number sets on the graph represent the working and spare capacity of each span. Because of spare capacity sharing, 50 spare channels protect an operational envelope of 71 protected working channels available for provisioning. This is a redundancy of −70 percent. The redundancy only improves with more nodes and/or higher connectivity. FIG. 3b-d illustrates three of the vast number of simultaneous end-to-end provisioning combinations supported within the envelope of protected working capacity shown in FIG. 3a. Changes between any of these demand patterns require no dissemination of state updates to other nodes or a centralized NMS. Note that under the PWCE concept, each span may also have any number of additional working channels, in excess of its PWCE <wᵢ⁰> quantity, that are usable for unprotected services (or, later, may be adaptively reconsidered as additions to the <sᵢ> quantity on some spans, as needed to create additional <wᵢ⁰> on other spans to track a non-stationary random demand pattern).

Another way to think about the PWCE concept is that it creates a volume of feasible operating states in an N(N−1)/2-dimensional space which corresponds to all vectors of simultaneous end-to-end demand quantities that can be routed without requiring more than wᵢ⁰ channels on any span. Any combination of end-to-end demands that can be routed without requiring the full <wᵢ⁰> capacity on any span is an operating state inside the envelope. As long as a span does not have wᵢ=<wᵢ⁰>, it is available under a simple OSPF topology view as an edge over which further working routing is supported. If wᵢ gets within a threshold of <wᵢ⁰> the link cost for OSPF routing over this span can (optionally) be increased to cause subsequent routing to hedge against hitting the envelope on this span. But as long as the random demand process is stationary and within a suitably dimensioned envelope, there are no state changes to be tracked by other nodes.

Statistical Stationarity Means No Changes in the Envelope

An important advantage of the PWCE architecture is that actions of any type related to ensuring protection occur only on the timescale of the statistical evolution of the demand pattern itself, not on the timescale of individual connections. Thus, any need for network management actions or state change dissemination is far less dynamic than the traffic itself. It takes a suitably large shift in the statistics of the demand pattern to require a logical change in the working envelope. Importantly, such actions also occur on a timescale where traffic behavior exhibits correlated observable trends that can be taken into account in capacity configuration planning. For instance, variations in total demand and pattern of demand have strong correlations day over day that would allow advance planning of several envelope configurations within the installed total capacities, each of which is known to suit the characteristic time of day to minimize any blocking. In contrast, SBPP works at the call-by-call timescale where individual departures and arrivals are essentially random, and routing is individually controlled by end users. This is an environment of inherently incremental reaction to the next arrival, not involving any opportunity for collectively optimized capacity use or routing strategies to enhance performance.

Thus, the protected envelope is very slowly changing or static over long periods of time, even in the most frenetically dynamic network. No matter how rapidly individual lightpath demands come and go at random, the envelope requirement will not change at all if the demand process is at statistical equilibrium. The envelope is only sensitive to nonstationary drift in the underlying pattern of random arrival/departure processes. This seems far simpler and more scalable to arbitrarily fast provisioning changes than making globally coordinated protection arrangements individually for every connection. The envelope needs to track only nonstationary drift in the statistics, not each arrival and departure event individually.

This approach is highly advantageous compared to the incrementally provisioned path model under which protection preplans have to be updated following each new service path establishment. It makes a span-protected PWCE network considerably more scalable than a corresponding SBPP network in terms of growth in both network size and service provisioning volumes handled per unit time. Under SBPP every connection establishment requires explicit consideration of a working path and a disjoint shared-backup path arrangement based on global network topology and shareability data. Under a span-protected PWCE every connection set-up is simply a single shortest-path routing problem within available wᵢ⁰ capacities of the protected envelope. We think this is one of the most important advantages of span-oriented protection.

More formally, we can define the state-space of all demand patterns (instantaneous combinations of connection states) that are inherently protected by a given working capacity envelope as follows.
G(N,S) is the network graph comprised sets of nodes N and spans S.
wᵢ⁰ is the number of working channels on span i∈S which are protected under the current distribution of spare channels on other spans j∈S|i≠j. It is a separate problem to determine wᵢ⁰ by any number of means depending on the protection mechanism, the network graph, and the spare capacity distribution. Suffice it here to say that the maximum number of working channels that can be protected by any given reserve network is computable yielding W={wᵢ⁰|∀i∈S} which is the network's protected working capacity envelope.
Dₖ is the matrix of point-to-point demand requirements in demand scenario k There is an essentially infinite number of possible demand scenarios.
M(G,Dₖ) is a process or algorithm for working path routing. It takes the graph G and maps the demand matrix Dₖ onto routes through graph. The output is W_{i,k}—the number of working channels on span i employed by M( ) to map demands of demand scenario k. M(G, Dₖ) can be invoked as a function to form the set. These represent the actual usage of working channels on span i when demand pattern k is routed over the graph by process M( ).

It is feasible to entirely serve demand matrix k through the current envelope W if W_{i,k}≦wᵢ⁰|∀i∈S. If this condition is true, we can say that Dₖ is “inside” envelope W under routing process M( )—a relationship we can denote as M(G, Dₖ)=Aₖ [symbol] W or just M(G, Dₖ) [symbol] W. Then the state-space for automated provisioning is definable as the set of all demand matrices Dₖ that are served and protected “inside” the working capacity envelope. That is:
\dot{D}_{W}≡{Dₖ|(M(G, Dₖ) [symbol] W)} (1)
By this we mean that \dot{D}_{W} is the set of all possible demand matrices where every demand is served and protected within the working capacity envelope W using a given process M( ) to route demands. Spare capacity does not come directly into these considerations even though all services are protected. This is the simple beauty of the PWCE concept: dynamic service provisioning has to consider only working path routing. There are no explicit considerations about spare capacity allocation or protection path arrangements because the envelope is by definition a protected operational working-space. As long as we operate within the working capacity envelope, we are automatically protected. The “stress” or operating proximity to limits of the envelope can be monitored at all times—the vector of operating margins is {wᵢ⁰—W_{i,k}}—but nothing needs to be done on the time scale of the individual path arrivals themselves.

In this framework every sequence of random demand arrivals and departures can be seen as a random-walk trajectory from one point k to a next point k in the space \dot{D}_{W} . The entire operating life of a dynamic network consists then only of single steps within this N(N−1)/2-dimensional space. Each step goes from a current Dₖ to an immediate neighbor Dₖ₊₁ state where one connection in Dₖ is removed to reach Dₖ₊₁ or to a neighbor state where one new connection is added to Dₖ to arrive at the next Dₖ₊₁. At all times during the operating walk, the routing process proximity to the envelope is measurable via the working capacity margins W−Aₖ={Wᵢ⁰−w_{i,k}}. At all times operation consists only of releasing paths or routing new working paths. The paradigm for handling dynamic demand is thus simplified to the equivalent of routing working demands on a point-to-point basis as if they were in an unprotected network of span capacities {w₁⁰}. In addition, any step to a neighbor in \dot{D}_{W} involves at most a unit change in any w_{i,k} value so the potential onset of blocking is always observable and easily employed to alter the behavior of M( ) itself to avoid blocking, or, moreover as we consider next, to adapt PWCE itself.

Design of a Static PWCE to Support Arbitrarily Dynamic Demand

A misconception in recent years has been that existing theory, for survivable net-work capacity design does not apply to optical networks with dynamic demand because those methods use a static demand matrix. A somewhat related misunderstanding has also been the assertion by some that with dynamic demand, restoration schemes cannot give an assurance of 100 percent restorability, again, because they were planned for a static demand pattern. But neither of these is true when dynamic demand is handled within an envelope of protected working capacity. Consider circuit-switched telephony network design: each call is random, but trunk group sizes are fixed and determined by a “static” matrix of Erlang traffic requirements. Designing a PWCE for a known set of random lightpath traffic intensities can similarly be a direct application of traffic theory (for the working capacity requirements) plus the addition of spare capacity design methods previously used in restorable network problems with “static” demand matrices. The interpretation of the demand matrix changes from representing an exact pattern of static forecast lightpath requirements to a requirement specification on the dimensions of the PWCE for which we must efficiently design protection capacity. Thus, another important aspect of the PWCE concept is that it relates the mathematical models for capacity planning for static demand matrices to the emerging view of highly dynamic demand arrival and departure processes under fully pre-provisioned inventories of channel capacity. Under the PWCE view of dynamic operations, the static demand matrix which we specify for a capacity design problem is simply reinterpreted as the generating exemplar that dimensions the working capacity envelope within which we want to serve dynamic demand. In this role a demand matrix no longer expresses the planner's forecast of exactly which future demands he/she expects to support, but rather his/her view of either:

1. The most demand expected to have to be supported on each O-D pair simultaneously, or,

2. In an analogy to traffic engineering, the number of lightpath “trunks” needed to serve the average instantaneous demand on each O-D pair at a target blocking level.

Regarding the second scenario, it is relevant to note that while blocking probability P(B) is quite nonlinear as a function of offered traffic (A) for a fixed number of servers (N), it is easily shown that under Erlang B the number of “servers” required (here lightpath requirements) to retain a low constant blocking probability is essentially linear above a few Erlangs. For example: N=5.5+1.17 A is accurate within +/−1 server for P(B)<0.01 from 5<A<50 Erlangs. Similarly N=7.8+1.28 A approximates P(B)=0.001 engineering within +/−1 server over the same range. The relevance is that design methods developed to solve apparently “static demand” problems also apply directly to the dynamic demand environment, through traffic theory. Simulation studies are not needed to generate the capacity requirements. If one knows the mean traffic intensities (A) that the simulation would have used, these values can be used directly in the equations given to generate the lightpath number requirements for the target blocking levels. Moreover, because N for a constant P(B) is nearly linear with A, the individual O-D pair path requirements can be added on spans that are common to the routes taken for various O-D pairs, thus generating the wᵢ quantities used for the subsequent span-restorable envelope protection design. In either case above, a process of shortest path mapping of these requirements onto the network graph generates a family of working capacity requirements on each span. This is in effect sizing the envelope: it fleshes out the number of wavelength channels to pre-provision for working services on each span. A separately solved spare capacity allocation problem can then stipulate the additional required number of spare channels to pre-provision so that the entire network envelope of working capacities is protected, regardless of the actual pattern of dynamic demand connections being supported at any time.

FIG. 4 illustrates the overall relationships. The main horizontal lines 402 and 404 divide the space into planning 406, protection 408, and real-time service provisioning activities or operations 410. In the overall concept portrayed, each of the different planning approaches leads to a specification of required working channel quantities, wᵢ, 412 on each span. Whether the interpretation is a forecast of static demands, or a forecast of mean dynamic traffic intensities, both lead ultimately to an as-built requirement that is static once placed on the ground. Once the planning of working quantities is complete, through whatever path is taken above, we enter the protection planning domain 408. If the wᵢ quantities are given, then an optimization problem called Spare Capacity Allocation (SCA) 414 dimensions the minimal total spare capacity 416 that will protect all wᵢ capacity on each span. Usually a side-effect of this process is to also produce all the restoration rerouting plans 418 that define the use of the spare capacity for each planned failure scenario. This information can be downloaded to each node in a centrally controlled scheme but is not required in a network that employs distributed preplanning.

Below the second line 404 in FIG. 4, the network is viewed in its operational service provisioning phase 410. The we quantities 412 define the resource pool or envelope that is used for dynamic service provisioning. The sᵢ quantities, protection preplans and protection mechanism, are unseen by the provisioning process but ready if needed. The service provisioning process need not directly address protection concerns at all within its routine of establishing and removing dynamic connection requests. The service provisioning process is using inherently protected capacity, instead of having to explicitly provision protection for each service path it establishes in step 420.

In planning, there are at least four approaches indicated on FIG. 4 that can lead to generation of the working capacity envelope requirements on each span:
1. A forecast is made 422 of the average (simultaneously required) number of lightpath connections on each O-D pair in Erlangs. Actual traffic is understood to be random in time, but characterized by these mean traffic intensities.
2. A specification of the simultaneous peak connection numbers required between all O-D pairs is given 424. Again, traffic is understood to be random in time, but a specification of this form characterizes the worst case simultaneous peak connection loads it is desired to support.
3. A forecast of exact static demand requirements expected between each O-D pair 425 is made 426.
4. No forecast of demand is given or used; instead, the amount of provisioned working capacity desired on each span is specified directly 428. This could be based simply on existing capacity availability or investment considerations, or to create an inventory of installed channels on every span over which to provide dynamic services. (In this context it is possible with recent advances to stipulate a fixed budget investment in total spare capacity and have the total volume of the PWCE maximized in terms of the number of provisionable channels present in the network as a whole. This is an especially attractive design strategy in the presence of either complete demand uncertainty or elastic demand, which can fully use any capacity provided on any route.)

Each of these planning scenarios gives a basis for determining the <wᵢ⁰> requirements of a protected working envelope. In the first scenario, the definition of PWCE span capacities is analogous to determination of trunk groups sizes in a circuit-switched network. The difference is that we specify end-to-end mean Erlang intensities, not the Erlang demand on individual full availability trunk groups. To first order, however, end-to-end Erlang requirements tend to add up linearly on the spans they traverse in common. While blocking probability P(B) is quite nonlinear as a function of offered traffic (A) for a given a number of servers (N), if it is the blocking requirement that is fixed, the number of servers required (here lightpath requirements on each span) is in fact, as discussed above, almost linear above a few Erlangs of offered load. We can therefore directly compute a traffic engineered number of lightpaths required end-to-end between each O-D pair. These traffic-engineered end-to-end requirements can then be added on spans because N is nearly linear with A for a constant P(B) on each span, thus generating the <wᵢ⁰> quantities of the required PWCE. A completely static spare capacity design model can then be used to compute the minimum cost <sᵢ> distribution that protects these <wᵢ⁰> quantities. In this methodology no simulation studies are needed to generate either the working or spare capacity requirements. All demand is dynamic, but standard traffic theory and static survivable network design methods are all we need to design an efficient low-blocking protected network design. In the second approach, shortest path routing of the simultaneous maximums similarly generates the <wᵢ⁰> quantities required. The third approach is what may be referred to as the traditional “static” planning model, which is useful for many study contexts, but does not directly consider the dynamic nature of demand patterns expected in the future. In the third framework, any other process or planning philosophy (or existing situation) can directly specify the <wᵢ⁰> quantities. These <wᵢ⁰> are then used directly in a conventional static survivable design problem to produce a cost-minimal set of spare capacities that protect the working envelope. Once in operation, as long as we operate within the working capacity envelope, service paths are automatically protected. However, the stress or operating proximity to limits of the envelope can also be monitored and exploited as follows.

Demand-Adaptive Definition of the Working Capacity Envelope

As so far described, we have a PWCE defined by a fixed set of wᵢ⁰ capacities. A planning process would determine wᵢ⁰ values of the required envelope, and this number of working channels would be turned up on the respective spans, commissioning the operational envelope that will be used for dynamic service provisioning. (A lesser number of sᵢ channels is also computed and turned up to protect the desired operating envelope). More generally, however, pre-existing transmission capacities may be in place that exceed the minimum (wᵢ⁰+sᵢ) channel requirements of the envelope design. This adds to the operational scope for the PWCE concept because it means that there is latitude for the partitioning of total capacity into wᵢ⁰ and sᵢ quantities to be adapted to suit evolving statistical traffic patterns. In other words, we can configure different working envelopes as long as the spare capacity needed to protect each is feasible under the installed total capacities. This leads to what can be called a dynamic PWCE mode of operation. The main difference is that the partitioning of the total provisioned capacity into working channels to form the PWCE and spare channels to protect it can be adapted by the network operator, but on a much slower time scale than that of individual connection requests. In fact, the simplest mode of operation is to let the routing process M( ) use as much wᵢ⁰ as it wishes on each span to realize required connection patterns, up to the point where a separate “observer” process indicates that a not-fully-protected state would be entered for if one more channel was seized on span i. To consider this context, let us define the following, in addition to terms above:
tᵢ is the total number of equipped channels on span i. T={tᵢ|∀i∈S} is the set of all such installed capacities.
u_{i,k}=tᵢ−w_{i,k} is the number of equipped channels on span i (including any explicitly designated as spare channels) that are not used by the current demand scenario, k. Uₖ={u_{i,k}|∀i∈S} is the set of all currently unused capacities.
kᵢ({G−i}, Uₖ) is the maximum number of paths currently feasible through the graph of unused channels, Uₖ, excluding span i. In other words, kᵢ( ) is a function that returns the maximal feasible number of restoration paths for span i in the current network state. In practice this could be a max-flow or ksp algorithm or obtained from a “mock restoration trial” call to a DRA (Distributed Restoration Algorithm) embedded in the network.
P(G, Uₖ, Aₖ) is the boolean decision problem that the network observer process executes:

$$P ( G , {U}_{k} , {A}_{k} ) = \{ \begin{matrix}1 if {k}_{i} ( \{ G - i \} , {U}_{k} ) \geq {w}_{i , k} ∀ ⅈ ∈ S \\ 0 otherwise\end{matrix} \qquad ( 2 )$$

In other words, P(G, Uₖ, Aₖ) is the yes/no answer to the question: Are all the actually used working channels {w_{i,k}}∈Aₖ in the current operating state fully restorable under the unused capacities uᵢₖ remaining in the network? In these circumstances the dynamic operating state-space for automated provisioning is enlarged to become:
\dot{D}_{T}≡{Dₖ|(M(G, Dₖ) [symbol] T)∩(P(G, Uₖ, Aₖ)=1)} (3)
The operating state space is comprised of all demand matrices Dₖ, which are routable in the available total capacity T (the first qualifier) and for which the working channels used on each span remain fully restorable (the second qualifier) under restoration routing that would use only the unused channels. Intuitively, Equation 1 and Equation 3 both define a vast domain of feasible protected operating states. The first scheme is simpler in that the PWCE is effectively fixed, reflecting a single partitioning of available capacity into working and spare channels. An off-line process could periodically redesign the PWCE to track demand evolution in this scheme, but no restorability observer is required. By addition of the on-line restorability observer the second scheme is enabled to continually exploit all installed capacity, implicitly adapting its own PWCE to the track variations in actual demand patterns to the greatest extent possible. The adaptive PWCE scheme amounts to being a network that is a self-planning demand-adaptive mesh restorable network which also monitors its own operating margins.

The restorability-assessing observer process can be either a centralized computation or a DPP (Distributed Pre-Planning)-type of background process which runs mock restoration trials in the unused “spare” capacity of the network itself. Each DPP trial provides the currently feasible maximum number of restoration paths for the simulated failure, that is k₁( ) in Equation 2. The restorability decision problem P(G, Uₖ, Aₖ) is therefore not a difficult one and a side effect of its execution is restorability margin information that lets a network operator see in advance if the limits of the protected envelope are being approached on any particular span. As an example, using k-shortest paths (KSP) as the route finding process for restoration:

```
Restorability Observer (G, U,A): P, margins( )
enter with graph G, unused capacities U, and actual-use capacities A;
for every i in S: {
  source[i] := first end node of span i;
  target[i] := other end node of span i;
  G′:= G−{i}; //G′ is the reserve network without span i//
  k[i] := ksp (G′, source[i], target[i], U);
  if (k[i] < w[i]) then {P=0; return};
      //unrestorability detected:(span i)//
  else margin[i] := k[i] − w[i,k] }
P=1;
return (with margins) //current state is fully restorable//.
```

The restorability observer is not run for every single path provisioned. Its job is rather only to sample and track the overall operating state, highlighting any spans where the restorability margin (in effect the remaining potential for expansion of the dynamic envelope) on a span is below some threshold. If the total number of working paths routed over a span just reaches kᵢ( ) then that would be the last service path that can be provisioned over that span within the protected envelope. The next path may have to take another route or be blocked. This is therefore the PWCE manifestation of blocking that similarly occurs in SBPP networks when a disjoint primary and backup path pair can no longer be found. But an important difference is that the onset of such blocking is observed in advance by the restorability observer process. If the demand pattern really is evolving (shifting its statistical means) so as to stress the envelope in one direction (one span) this evolution is seen in advance as the slow erosion of the average restorability margin on the respective span. So capacity augmentation efforts and/or changes in routing policy can be effected proactively rather than in response to the hard onset of actual blocking. 34

Rather than simply starting to block certain new connection requests, changes in the routing policy M( ) can avoid or delay the encroachment on restorability limits on certain spans, or priority service class policies can also be effected to soften or avoid an approach to the envelope limits. In contrast under SBPP each end node pair runs its own process for primary (working) and backup path protection arrangements and so can suddenly enter blocking conditions without any warning or advance knowledge as the total capacity is consumed by other service path pairs in the same network.

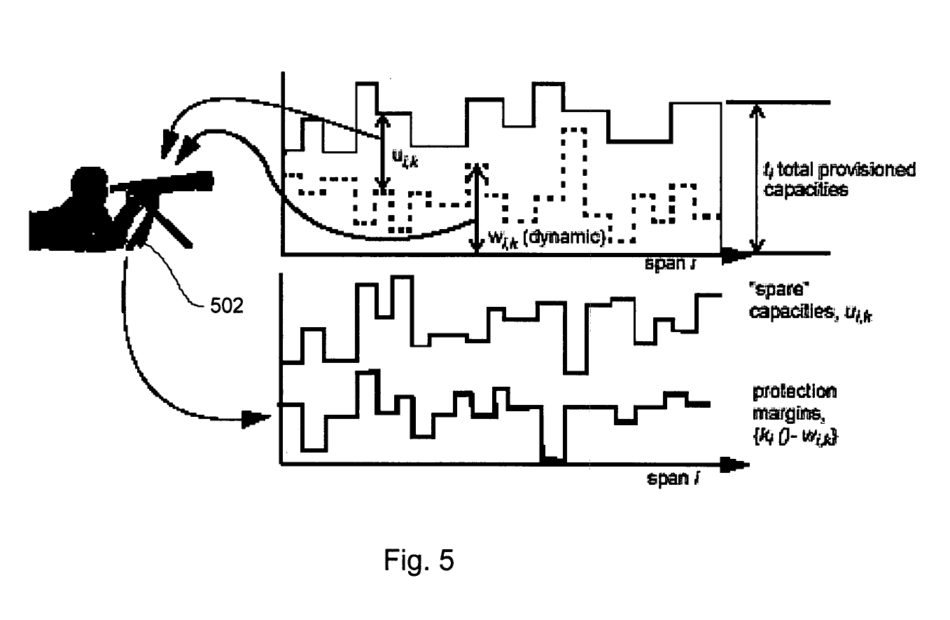

FIG. 5 summarizes the overall concept of a PWCE that is self-sizing within the available total capacity and restorable state boundaries of the network and is observed either centrally or via DPP to define the working capacity limits of its dynamic provisioning operations, represented by observer 502. Note that the protection margin on a span is not the difference between its own working and spare capacity. Rather, in span restoration it is spare capacity on other spans that protects a given span, so the protection margin is the difference between the maximum number of feasible restoration paths for span i, i.e., kᵢ( ), and the current working capacity usage on span i, i.e., w_{i,k}. So a span that has a lot of spare capacity may itself not have a high protection margin. With the observer, the approach to stating where new service paths would potentially have to be blocked is “soft” and may be avoided altogether if a statistical trend in a certain direction is temporary, and not sustained. If the observer reports that restorability margin has eroded below certain limits on a span, further routing can be discouraged, but not ruled out, on that span until the margin rebuilds. If an OSPF/CR-LDP type of routing process is being used then it would suffice for the observer to simply publish an updated “edge cost” for any span whose restorability margin was below some threshold. Similarly, by lowering edge costs it can encourage new paths to take routes over spans with high restorability margins. If centrally computed, the restorability observer task is in O(|S||N|²) (based on O|N|²) for the ksp algorithm). However, a restorability observer that is tracking the Wink state can use a pre-prepared route table to answer the question P=1 or 0 ? in O(1) (i.e., table-lookup time). Table-based methods for such fast calculation of the current span restorability state are known in the art. This type of calculation can be used to preplan a number of daily operating configurations in a multᵢ hour planning framework (where daily traffic patterns tend to repeat the same sequence of nonstationary evolutions), or it can be used online only as needed to adaptively reconfigure the envelope to match current demand patterns.

Graceful Onset to Limits of the Envelope

Of course, if the total demand volume or pattern of demand is brought to some extreme condition, blocking is inevitable with either PWCE or SBPP schemes operating with any finite installed capacities. However, continual observability of the <wᵢ⁰−Wᵢ> margins against blocking remains under PWCE as the adaptive redefinition of <sᵢ> is stretched right to its limits. Consequently, many strategies (e.g., changes in the shortest path routing policy used by nodes) can be effected to still further avoid or delay the encroachment on service provisioning. One way to do this is for the NMS to issue updated routing cost coefficients for nodes to use in their OSPF-type source routing calculations, or the nodes themselves to issue removal LSAs for any span approaching the envelope. (The removal is only from availability for further new service provisioning). These measures force the routes chosen by other nodes for continuing service provisioning to begin deviating from true shortest path routing to help sustain yet fiuther provisioning without blocking. Another range of strategies can involve temporary suspension of the protected service status of certain service classes to further hedge against hitting the edges of the operating envelope. Under SBPP it is not clear if there is any such overall observability of the approach to blocking conditions and corresponding options for graceful degradation.

There are thus two levels that gracefully counteract the onset of blocking as physical limits on capacity are reached. Envelope adaptation is first exploited to its limits (while keeping all routes on true shortest paths for efficiency). Following that, edge cost coefficients are updated or a routing withdrawal LSA is announced to begin deviating new service paths from shortest routes on the congested span(s). The approach to network states where new service paths would potentially have to be blocked is thus graceful and observable, and also may be avoided altogether if a statistical trend in a certain direction is temporary and not sustained. Ultimately, of course, under enough sheer growth in demand or extreme imbalances in relative demand pattern, the limits of the PWCE can be reached because the installed total capacities arc finite. At this point blocking is inevitable, as with corresponding limits to SBPP. But in the PWCE case, the progression toward the limits of the envelope is highly observable over the timescale of evolution of the demand pattern. Thus, ongoing inputs to the physical capacity planning process is a natural side-effect of the adaptive PWCE scheme.

PWCE Concept in the Context of p-Cycles

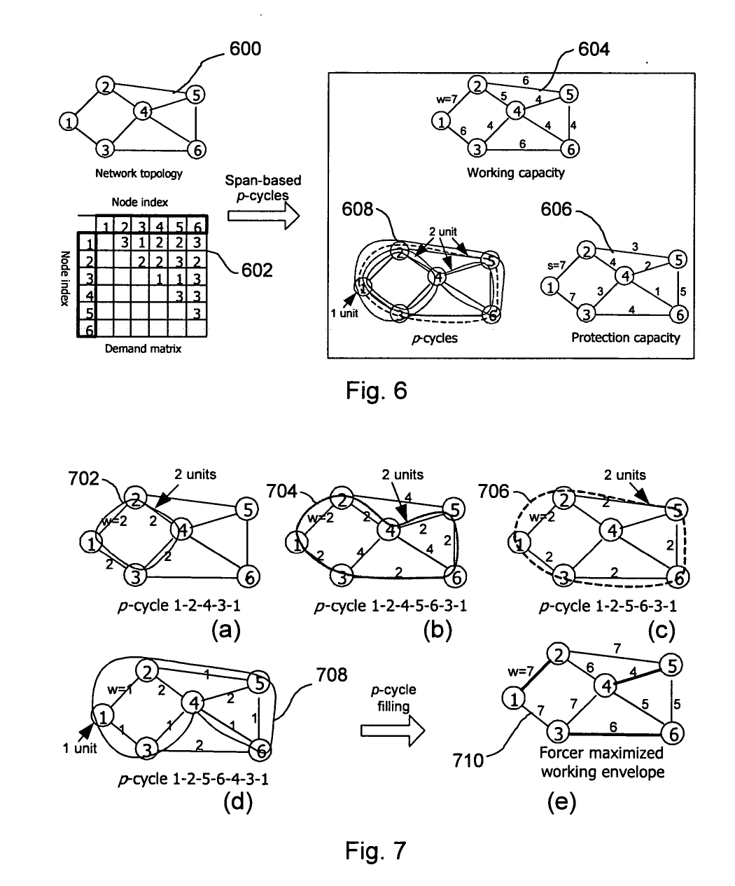

A PWCE in a network protected by p-cycles is similar to a span-restorable mesh network. The only difference is that instead of the spare capacity being assembled on demand into a required path set for restoration of a specific failure that arises, a set of p-cycle structures is established in which all spare channels are pre-connected and have pre-defined the protection relationships with the individual channels of working capacity. FIG. 6 illustrates a PWCE designed based on the conventional p-cycle-based survivable network design. A six-node network 600 and a demand matrix 602 are shown on the left side, and the working and protection capacities 604 and 606, respectively, based on the ILP model for ap-cycle network are shown on the right side. The set of working channels forms a PWCE, capable of accepting dynamic survivable service requests from various node pairs. In this design four p-cycles of various capacities protect all the working channels, as represented by 608.

Forcer-based Envelope Volume Maximization

In the previous example, a PWCE is constructed based on conventional p-cycle network design. Given a “static” matrix of exact demand requirements, working capacity requirements are first generated on each span by routing demands via shortest paths. Subsequently, based on the working capacities, p-cycles and associated spare capacities are designed to guarantee full protection of the working capacities. Given the total spare capacity that this results in we can ask, however, if the corresponding set of working capacities we started with is in fact unique and maximal in the envelope sense. To address this, we consider the idea of the volume maximization in PWCE construction. In doing so we exploit the “forcer” structure of the initial p-cycle network design. The basic concept is that when a span-based survivable network is designed, the required spare capacity on each span is “forced” by working capacity on a certain span (or spans), called forcers. The spare capacity has to be adequate to fully restore the failure of the forcer(s), but the restoration of the non-forcer spans may not require the same amount of spare capacity. In O.R. terms, if the reserve network is designed by ILP, then forcer spans are associated with the binding constraints in the system of spare capacity inequalities in a model such as that in M. Herzberg, S. Bye, A. Utano, “The hop-limit approach for spare-capacity assignment in survivable networks,” IEEE/ACM Trans. Networking, vol.3, Dec. 1995, pp. 775-784. For the failure of the non-forcer spans, (viewed individually) the spare capacity in the network appears to be over-provisioned. For them, a smaller amount of spare capacity would suffice. In a certain sense, it is inefficient for the non-forcers. The idea here is, for envelope design, to make full use of the spare capacity in the network by raising the number of working channels on non-forcer spans so that they become co-forcer spans. The result is that a greater total volume of working capacity can be established under the same spare capacity as the conventional survivable network design produced for the static target demand matrix. The PWCE designed with forcer structure exploitation has the largest envelope capacity, wherein all of the spans become equal co-forcers of the spare capacity.

FIGS. 7(a) to (e) illustrates this forcer-filling effect. Under the conventional design, we are given working capacity of spans as shown in FIG. 6, which is mapped from the demand matrix based on the demand-splitting shortest path routing. If there are more than one shortest routes simultaneously existing between a node pair, the demand units between the node pair are allocated onto each of the routes, as equally as possible subject to retaining integer demand flow on each route. To protect them, four p-cycles 702, 704, 706, and 708 are needed as shown in FIGS. 7(a) to (d), respectively. Three p-cycles 702, 704 and 706 each require two units of spare capacity and one p-cycle 708 needs one unit of spare capacity. In this design, we find that there are three forcers: spans (1-2), (3-6), and (4-5), while all the other spans are non-forcers. We then employ p-cycle capacity filling to exploit the forcer structure to maximize the PWCE volume. For each p-cycle with a certain spare capacity we try to fill a working capacity, which is the same as the p-cycle capacity, to each on-cycle span, and a working capacity, which is a double of the p-cycle capacity, to each straddling span. These filled working capacities are fully protected by the same p-cycles. For example, in FIG. 7(b), as p-cycle (1-2-4-5-6-3-1) has two units of spare capacity, we can fill two units of working capacity on each of the on-cycle spans (1-2), (2-4), (4-5), (5-6), (6-3), and (3-1) and four units of working capacity on each of the straddling spans (2-5), (3-4), and (4-6). For the remaining three p-cycles, similar filling processes can be carried out. All the working capacities filled to the p-cycles are summed to form the working envelope shown in FIG. 7(e). Subject to using no more spare capacity than the initial design, this forms a volume-maximized PWCE. The new PWCE has a total of 54 working channels for service provisioning, compared to 46 for the initial design. Thus when constructing a PWCE we can “volume-maximize” the PWCE with respect to the spare capacity that is required in any case for an initial design to some static forecast demand matrix. It will be understood that forcer-filling can be applied to other protection schemes with PWCE.

Demand Matching Effect

Given a traffic demand matrix which reflects traffic loads between node pairs, if the shortest path algorithm is employed to route demand services, a span-based network load distribution can be generated with some spans traversed by high traffic loads and some spans by low traffic loads. For a span with a high traffic load, a high volume working capacity should be assigned so as to reduce the possibility that the span lacks free capacity. Likewise, for a span with a low traffic load, a small volume of working capacity is needed so as to make full use of the assigned working capacity. For a given network load distribution, this is an important issue on how to assign network resource efficiently so as to match the network load distribution and achieve the best overall network throughput.

Given the network design budget, we can design a network with certain network capacity distribution, wherein the sum of the capacity cost of each span never exceeds the budget and the capacity on the spans follows a certain distribution pattern. For the network load distribution and the network capacity distribution the matchness between them can affect the network overall throughput. If the two distributions match well, the network is expected to achieve a good throughput. For example, if a span with a high traffic load is assigned a large volume of capacity, and a span with a low traffic load is assigned a small volume of capacity, we can reasonably expect that the network have a good throughput. On the contrary, if the distributions cannot match each other well, the overall network throughput may be affected greatly. Likewise, if a span with a high traffic load were assigned little capacity, while a span with a low traffic load were assigned an over-provisioned capacity, then situations would appear as some spans extremely lack capacity, while some spans have too much redundant capacity.

To quantify the degree of match between the two distributions, the correlation coefficient is used to measure this. For the network load distribution, we have a load vector (lᵢ), where i is the index of the spans and each entry lᵢ represents the traffic load on span i. Similarly, for the network capacity distribution, we have a capacity vector <tᵢ>, where each entry is the assigned capacity on a span. To examine the degree of match between the two distributions, we use the correlation coefficient φ(<lᵢ>,<tᵢ>), on the two vectors. The definition of the correlation coefficient is as follows:

$$ϕ ( 〈 {l}_{i} 〉 , 〈 {t}_{i} 〉 ) = \frac{{\sum }_{ⅈ ∈ S} ( {l}_{i} - \overline{l} ) \cdot ( {t}_{i} - \overline{t} )}{\sqrt{{\sum }_{ⅈ ∈ S} {( {l}_{i} - \overline{l} )}^{2}} \cdot \sqrt{{\sum }_{ⅈ ∈ S} {( {t}_{i} - \overline{t} )}^{2}}} \qquad ( 4 )$$

where S is the set of the spans in the network, \overline{l} and \overline{t} are the means of traffic loads and capacities on the spans respectively.

When the correlation coefficient is equal to a positive one, the two distributions hold a perfect matching relationship and the vector entries in the two distributions are proportional. The other extreme case is that the correlation coefficient could be a negative one. In that case, the two vectors hold an absolutely antipodal relationship, which means that when one distribution has an increasing trend, the other distribution tends to decrease, and vice versa. We expect that a network has the highest throughput when the two distributions hold a perfect matching relationship and has the lowest throughput when the two distributions hold an antipodal relationship.

In the PWCE construction, the capacity budget can be span-based or network-wide. For the former, a fixed number of network capacity has been deployed on each span (e.g., the number of deployed wavelength channels), which is not subject to any change, while for the latter, a total network design budget is given, but there is no constraint on how to distribute this budget on each span (e.g., in some greenfield-like designs). As a further extension of the capacity budget, instead of the total capacity budget, which is the sum of the working and protection capacities, only a protection capacity budget is given on a network or span basis, while the working capacity, which corresponds to the PWCE size, is a variable beyond the budget constraint. Since the throughput of a designed network is related to the correlation coefficient between the network load distribution and the network capacity distribution, when designing a PWCE, it would be helpful if the envelope can match the network load distribution well. We can try to add some additional constraints to the design so as to steer the “shape” of PWCE similar to the network load distribution. We call such a kind of design “structuring” design, and the designs without matching effort the “non-structuring” design.

The structuring designs have both pros and cons to the network throughput. The PWCE constructed by the structuring designs has a good positive correlation coefficient with the network load distribution and therefore is similar in shape to the latter, so we expect that such a design can improve the overall network throughput. However, on the other hand, to guarantee a high correlation coefficient between the capacity distribution and the load distribution, an extra constraint is employed in the design, which can reduce the overall volume of the envelope compared to the one without such a constraint. With a smaller envelope, the network can be foreseen to carry a smaller throughput. The matchness between the two distributions can increase the throughput, but the concomitant constraint would reduce the throughput. Now the question before us is: which factor overall dominates to increase or decrease the throughput? The experiment results reported later show that the factor of “structuring” overwhelms the factor of volume to improve the overall network throughput largely when compared to the one without structuring.

Various Design Capacity Budgets

To construct volume-maximized PWCEs, a budget-limit of spare (or total) capacity investment needs to be defined to constrain the problem. The budgets can be span-based or network-wide. A span-based budget means that a specific maximum number of spare channels is allowed on each span. With a whole-network budget the constraint is only on total spare capacity of the network as a whole. As such, a network-wide budget normally has more freedom in the PWCE construction than a span-based budget. Alternatively capacity budgets can be defined on the total working and spare capacity of each span or the whole network. In summary, there are four possible types of budget scenario to consider:

(i) Span-based spare capacity budget where a certain maximum number of spare channels is allowed on each span. The limit can differ for each span.

(ii) Span-based total capacity budget where a budget of total capacity is set on each span. The total capacity is the sum of working and spare capacity, but there is no constraint on how to split the total span capacity into the working and protection capacities.

(iii) Network-wide spare capacity budget where a total spare capacity budget is set on a network-wide basis. No constraints are set on the distribution of this total spare capacity.

(iv) Network-wide total capacity budget, where a limit applies to the sum of all network-wide working and protection capacities, but without any constraint on distribution or working/spare split.

ILP Design Models for PWCEs

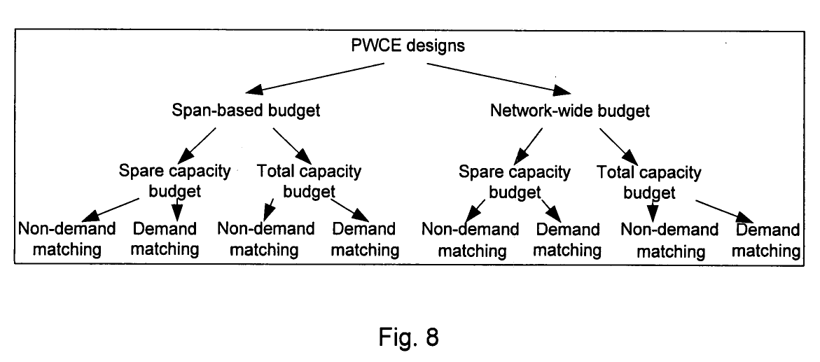

There are various methods to construct PWCEs. One way is to use the conventional span-based p-cycle design method. Under such a method, there are often many non-forcer spans, so the envelope designed is not optimal (in the volume-maximized sense). It thus does not fully exploit the spare capacity from a PWCE standpoint. To achieve a better efficiency, we employ the forcer-structure-exploitation process to construct volume-maximized PWCEs, where the working capacity of the PWCE on each span is elevated to bring the span into a co-forcer relationship with the initial forcer spans. In G. Shen, W. D. Grover, “Exploiting forcer structure to serve uncertain demands and minimize redundancy of p-cycle networks,” in SPIE OPTICOMM'03, pp. 59-70, three ILP models were developed to exploit this form of extra PWCE capacity under the forcer structure of the conventional designs. Here, we extend these models to construct PWCEs under various budget constraints. We also consider the demand matching effect in the designs. This involves a total of eight possible design combinations, summarized in FIG. 8. Some parameters and variables common to all models are as follows:

Sets:

S is the set of spans of a network.

P is the set of all eligible cycles of the network (note that number of finally selected cycles is normally much smaller than that of the eligible cycles).

Parameters:

Xᵢ^{j} takes the value of two if span i is a straddler on cycle j, one if span i is an on-cycle span, zero otherwise.

Pₖ^{j} takes the value of one, if cycle j uses span k, zero otherwise.

lₖ is the predicted relative load on span k, which can be computed from a given demand-forecasted matrix based on the shortest path algorithm. If there is more than one shortest route existing between the same node pair, the demand units are evenly split onto each of the shortest routes.

sₖ is the number of assigned spare channels on span k. Note that in some design cases, this is a variable, not a parameter.

Tₖ is the total number of deployed channels on span k, among which some channels will be assigned as the working capacity and the rest will be assigned as the shared spare capacity.

Bₛ is the total network-wide spare capacity budget.

B_{w+s} is a total network-wide capacity budget.

α is factor which mediates the trade-off between structure-shaping and volume maximization of a PWCE.

Variables:

wₖ is the number of protected working channels on span k.

<wₖ⁰> defines a PWCE design result.

nⱼ is the number of copies of unit cycle j preconfigured to offer span failure protection.

λ is a shape-asserting factor which structures the PWCE relative to the target load distribution.

Now the ILP models under the eight combinations are as follows:

Model A: Volume Maximized under Span-based Spare Capacity (Non-Structuring)

Objective:

$$maximize {\sum }_{k ∈ S} {w}_{k}$$

Constraints:

$$\begin{matrix}{\sum }_{j ∈ P} {X}_{i}^{j} \cdot {n}_{j} \geq {w}_{i} ∀ ⅈ ∈ S & ( 5 ) \\ {s}_{k} \geq {\sum }_{ⅈ ∈ S} {P}_{k}^{j} \cdot {n}_{j} ∀ k ∈ S & ( 6 )\end{matrix}$$

In this model we assume a given set of spare channel counts on each span. These may typically have arisen from a nominal design to a nominal forecast or they may simply be the unused capacities of existing spans. Within this spare capacity environment the problem is to form a set of p-cycles that protects the largest total number of working channels on spans of the network as a whole, i.e., to maximize the bulk volume of PWCE. Constraint (5) states that all the working capacity of the envelope is protected by the p-cycles. Constraint (6) ensures that the spare capacity used to form the set of p-cycles never exceeds the budget on each span.

Model B: Combined Demand Matching and Volume Maximization under Span-based Spare Capacity (Structuring)

Objective:

$$maximize \{ λ + α \cdot {\sum }_{k ∈ S} {w}_{k} \}$$

Constraints:

Subject to constraints (5) and (6) as above, to which we add
wₖ≧λ·lₖ ∀k∈S (7)

In this model we assume a given set of spare channel counts on each span. Within this spare capacity environment the problem is to form a set of p-cycles that then protects the largest possible total number of demand matching working channels on the spans of the network as a whole. However, we now have a bi-criterion objective function which also tries to shape the envelope to be similar to the network load distribution by bringing in a shape factor λ and constraint (7), which puts utility on the similarity between the PWCE and the target network load distribution. The overall objective is now a trade-off between envelope volume and shape matching with load distribution. In the test results however the trade-off factor a is set to be a very small value which guarantees that the maximization of the shape factor λ as the primary objective. As a result we tend to see λ maximized until the spare capacity cannot guarantee restorability of the envelope if the factor is further increased. The secondary objective is to maximize the envelope volume after it cannot be fuirther enlarged under the exact shape of the predicted network load distribution.

Model C: Volume Maximization under Span-Based Total Capacity (Non-Structuring)

Note that with this and subsequent models, sₖ becomes a variable as well. In this model we assume a given set of total deployed channel counts on each span. This is closest to the situation of an existing deployed network of transmission systems. Within this total capacity environment the problem is to split the total capacity on each span into two parts. One functions as the PWCE and the other as the protection capacity to form a set of p-cycles offering protection for the envelope.

Objective:

$$maximize {\sum }_{k ∈ S} {w}_{k}$$

Constraints:

Subject to constraints (5) and (6) as above, to which we add
Tₖ≧w_{w}+sₖ ∀k∈S (8)

The objective is to maximize the size of the PWCE. The total capacity used as working and spare channels on each span never exceeds the total present.

Model D: Combined Demand Matching and Volume Maximization under Span-Based Total Capacity (Structuring)

This model is similar to model B to maximize the envelope in the shape in line with the network load distribution. The only difference between them is that this model has a span-based total capacity budget, while model B has a span-based spare capacity budget.

Objective:

$$maximize \{ λ + α \cdot {\sum }_{k ∈ S} {w}_{k} \}$$

Constraints:

Subject to constraints (5), (6), (7), and (8) as above.

Model E: Volume Maximization under Network-wide Spare Capacity Budget (Non-Structuring)

Objective:

$$maximize {\sum }_{k ∈ S} {w}_{k}$$

Constraints:

Subject to constraints (5) and (6) as above, to which we add

$${B}_{s} \geq {\sum }_{k ∈ S} {s}_{k} ∀ k ∈ S \qquad ( 9 )$$

This model is similar to model A, except that instead of a set of spare channel counts on each span, a network-wide total spare capacity budget is given in this design. The objective is to maximize a PWCE with the protection of the p-cycles formed by the network-wide spare capacity budget. We do not put a constraint on how the spare capacity budget should be assigned onto each span as long as the sum of them never exceeds the total network-wide spare capacity budget. Since the constraint on the spare capacity budget is network-wide, instead of span-based, such a design can construct a larger envelope than model A. The additional constraint (9) is to ensure that the sum of the spare capacity assigned to each span never exceeds the total network-wide spare capacity budget.

Model F: Combined Demand Matching and Volume Maximization under Network-Wide Spare Capacity Budget (Structuring)

Objective:

$$maximize \{ λ + α \cdot {\sum }_{k ∈ S} {w}_{k} \}$$

Constraints:

Subject to constraints (5), (6), (7), and (9) as above.

This model is similar to model B to maximize the envelope in the shape in line with the predicted network load distribution. The only difference is that the current model has a network-wide spare capacity budget, while model B has a span-based spare capacity budget.

Model G: Volume Maximization under Network-wide Total Capacity Budget (Non-Structuring)

Objective:

$$maximize {\sum }_{k ∈ S} {w}_{k}$$

Constraints:

Subject to constraints (5) and (6) as above, to which we add

$${B}_{w + s} \geq {\sum }_{k ∈ S} ( {w}_{k} + {s}_{k} ) ∀ k ∈ S \qquad ( 10 )$$

This model is similar to model C except that we now assume the total channel count budget is network-wide, not of a per-span nature. The design assigns the total network-wide channel count onto each span. The capacity on each span can be further divided into the working part and the protection part. The working parts on all the spans make up a PWCE and the protection parts on all the spans become the spare capacities to protect the envelope. There are many possible combinations for the assignment. The best assignment is the one that generates a PWCE having the largest volume. Constraint (10) is added to guarantee that the sum of network-wide working and protection capacity never exceeds the total network-wide capacity budget.

Model H: Combined Demand Matching and Volume Maximization under Network-Wide Total Capacity Budget (Structuring)

Objective:

$$maximize \{ λ + α \cdot {\sum }_{k ∈ S} {w}_{k} \}$$

Constraints:

Subject to (5), (6), (7), and (10) above.

This model is similar to model D to maximize the envelope in the shape in line with the predicted network load distribution. The only difference between them is that this model has a network-wide total capacity budget, while model D has a span-based deployed capacity budget.

Practical Applications of the Design Models

According to various assumptions and environments, different volume-maximized PWCE design models may be applied in practice. For example, if a set of spare capacities on each span is given, which can be the spare capacities that have been assigned there by the conventional design, we may employ the model A or B to construct envelopes for the existing network and some extra protectable working capacity can be exploited without adding any extra spare capacity. Similarly, if a set of total capacities on each span is given, which can be the systems having been deployed, we may re-optimize the network design by employing the models C or D to make the spare capacity more efficient for protection and exploit more protected working capacity by maximizing the PWCE. For greenfield network designs, where a network-wide total capacity budget is given, we can design a new network, which is the most efficient in the network resource utilization for a certain network topology. For this, we may employ the models E, F, G, or H to construct the largest-volume PWCE and to shape it to accommodate the most demand.

Immaterial modifications may be made to the embodiments of the invention described here without departing from the invention.

1. A method of protecting a telecommunications network, the telecommunications network having working capacity, the method comprising the steps of:
establishing a set of spare capacity necessary to protect at least some of the working capacity of the telecommunications network, the set of spare capacity defining a protected working capacity envelope; and
increasing the protected working capacity by analyzing and using spare capacity within the protected working capacity envelope.

2. The method of claim 1 wherein establishing a set of spare capacity comprises using an adaptive span restoration strategy.

3. The method of claim 1 wherein establishing a set of spare capacity comprises using a pre-planned span protection strategy.

4. The method of claim 1 wherein establishing a set of spare capacity comprises using cycle covers.

5. The method of claim 1 wherein establishing a set of spare capacity comprises using p-cycles.

6. The method of claim 1 wherein establishing a set of spare capacity comprises using bidirectional line switched rings.

7. The method of claim 1 wherein analyzing and using spare capacity within the protected working capacity envelope comprises using forcer analysis

8. The method of claim 1 wherein analyzing and using spare capacity within the protected working capacity envelope comprises using a restorability observer.

9. The method of claim 8 wherein the restorability observer adapts the protected working capacity envelope based on current demand patterns.

10. The method of claim 1, wherein establishing a set of spare capacity comprises using a capacity budget.

11. A method of operating a telecommunications network, the telecommunications network having working capacity, the method comprising the steps of:
establishing a set of spare capacity necessary to protect at least some of the working capacity of the telecommunications network, the set of spare capacity defining a protected working capacity envelope;
receiving a request to transmit information between two nodes;
determining the lowest cost route through the protected working capacity envelope between the two nodes; and
connecting the nodes and spans along the lowest cost route to establish a connection between the two nodes.

12. The method of claim 11 wherein receiving a request to transmit information between two nodes further comprises the step of classifying the route as assured protection, best effort, no protection, or preemptible.

13. The method of claim 12 wherein the classification of the route is changed as the limits of the network capacity are approached.

14. The method of claim 11 wherein determining the lowest cost route is based on factors selected from the group consisting of the number of hops in the route, the amount of available working capacity in each span of the route, the physical distance of the route, cost coefficients for spans, and cost coefficients for nodes.

15. The method of claim 14 wherein determining the lowest cost route comprises spans or nodes updating cost coefficients based on the amount of working capacity being used.

16. The method of claim 11 wherein establishing a set of spare capacity comprises using cycle covers.

17. The method of claim 11 wherein establishing a set of spare capacity comprises using a pre-planned span protection strategy.

18. The method of claim 11 wherein establishing a set of spare capacity comprises usingp-cycles.

19. The method of claim 11 wherein establishing a set of spare capacity comprises using bidirectional line switched rings.

20. The method of claim 11 further comprising analyzing and using spare capacity within the protected working capacity envelope to increase the protected working capacity.

21. The method of claim 11 wherein establishing a set of spare capacity defining a protected working capacity envelope further comprises using a capacity budget.
